(19) United States
(12) Patent Application Publication
(10) Pub. No.: US 2008/0199313 A1
(43) Pub. Date: Aug. 21, 2008

(54) Method of manufacturing rotor and exhaust turbo-supercharge incorporating the rotor

(76) Inventors: Kenji Nitta, Kanagawa-ken (JP); Toshimitsu Tetsui, Nagasaki-ken (JP)

Correspondence Address: WENDEROTH, LIND & PONACK, L.L.P., 2033 K STREET N. W., SUITE 800, WASHINGTON, DC, 20006-1021, US

(21) Appl. No.: 11/987,075

(22) Filed: Nov. 27, 2007

(30) Foreign Application Priority Data
Feb. 21, 2007 (JP) 2007-041481

(51) Int. Cl. F01D 25/28; B23P 15/04; F01D 5/02; F01D 5/30

(52) U.S. Cl. 415/216.1; 29/889; 416/213 R

(57) ABSTRACT

Provided are a method of manufacturing a brazed rotor composed of a wheel and a shaft joined to the former by brazing, having a durability and a reliability which can be enhanced without increasing the manufacturing man hours, and a turbine rotor for an exhaust turbo-supercharger. The wheel having a disc portion formed at its outer periphery with blades, and a rod-like shaft are arranged in a furnace, being opposed to each other at their surfaces to be joined with a brazing solder being interposed therebetween, and infrared radiation is irradiated onto a side part of the wheel so as to heat the surfaces to be joined up to a temperature in a range from 1,000 to 1,080 deg. C. in order to melt the brazing solder, thereby the wheel and the shaft are joined by brazing to each other at their surfaces to be joined.

### BACKGROUND OF THE INVENTION

1. Field of the Invention

The present invention relates to a method of manufacturing a rotor which is adapted to be used as a turbine rotor in an exhaust turbo-supercharger for an internal combustion engine and which is composed of a wheel having a disc portion formed at its periphery with blades, and a shaft formed in a rod-like shape and joined to the wheel by brazing, and is also relates to an exhaust turbo-supercharger utilizing the above-mentioned rotor.

2. Description of the Related Art

In a relatively small-sized exhaust turbo-supercharger used in a vehicle engine or the like, there has been, these years, used a turbine rotor in which a wheel having a disc portion formed at its periphery with blades is joined to a shaft formed in a rod-like shape by brazing.

A Patent Document 1 (Japanese Patent Laid-Open No. H06-159085) discloses a technology of a method of manufacturing the above-mentioned brazed turbine rotor, as an example.

In the above-mentioned technology, a wheel made of a Ti—Al group alloy having a high strength at a high temperature and a turbine shaft made of a heat-resisting steel are arranged in an inert gas atmosphere within a furnace, their surfaces to be joined being opposed to each other through the intermediary of a brazing solder, then the turbine shaft is high-frequency heated so as to heat their surfaces to be joined by a heat thus transmitted thereby up to a high temperature of about 1,100 deg. C. in order to melt the brazing solder for joining the wheel and the shaft at their surfaces to be joined, and thereafter the turbine shaft is subjected to a heat-treatment in order to make up for lowering of its strength due to high temperature heating during the brazing.

However, a conventional method of manufacturing a brazed turbine rotor as disclosed in the Patent Document 1 (Japanese Patent Laid-Open No. H06-159085) has raised the following problems which should be solved:

That is, only the turbine shaft which has a simple configuration and which can be high-frequency heated is heated in order to heat up the surfaces to be joined which are arranged face-to-face through the intermediary of a brazing solder, up to a temperature of about 1,100 deg. C. by a transmitted heat thereby since the wheel which incorporates the blades so as to have such a complicated configuration that it cannot be heated up in view of its high-frequency characteristic, in the case of brazing the wheel and the shaft to each other within a furnace. Thus, the temperature of the shaft is increased greatly exceeding 1,100 deg. C., and accordingly, Fe is diffused in the shaft so as to react with C in the Ti—Al group alloy added with C, and as a result, extremely fragile carbide is formed at the interface between the surfaces to be joined. Thus, the toughness of the joined part thereof is lowered, that is, it is likely to cause such a disadvantage that the strength of the joined part becomes insufficient.

Further, although only the shaft alone is high-frequency heated as stated above, a large residual stress is generated in the joined part thereof after cooling thereof since the linear expansion coefficient of the material of the shaft is large, and accordingly, since the joined part is fragile as stated above, there would be possibly caused such a disadvantage that the joined part cracks due to the residual stress or the joined part is broken by an external force.

Further, the above-mentioned problems can be solved more or less by subjecting the shaft side to heat-treatment after the wheel and the shaft are joined by brazing. However, in this case, the heat-treatment should be additionally carried out, and as a result, the man hours for manufacturing the turbine rotor are increased.

### SUMMARY OF THE INVENTION

The present invention has been devised in view of the above-mentioned problems inherent to the prior art, and accordingly, an object of the present invention is to provide a method of manufacturing a brazed rotor composed of a wheel and a shaft jointed to the former by brazing, in which the strength of the joined portion between the wheel and shaft can be enhanced without increasing the man hours for manufacturing thereof, in order to enhance the durability and the reliability thereof, and also to provide a turbine rotor for an exhaust turbo-supercharger.

To the end, according to the present invention, there is provided a method of manufacturing a rotor formed by joining a wheel composed of a disc portion formed at the outer periphery thereof with blades, to a shaft which is formed in a rod-like shape, with the use of brazing, characterized by the steps of arranging the wheel and the shaft face-to-face at their surfaces to be joined, in a furnace, with a brazing solder being interposed therebetween, irradiating infrared radiation onto the wheel side part in order to heat the surfaces to be joined up to a temperature of 1,000 to 1,080 deg. C. so as to melt the brazing solder thereby to join the wheel and the shaft at their surfaces to be joined.

According to the present invention as stated above, preferably, the heat-treatment for the shaft after joining thereof can be eliminated.

Further, a rotor which is manufactured by using the above-mentioned manufacturing method, and which comprises a wheel composed of a disc portion formed at the outer periphery thereof with blades, and a rod-like shaft joined to the wheel by brazing, characterized in that the wheel is a made of a material composed (by wt. %) of 29 to 32 of Al, 10 to 17 of Nb, 0.05 to 0.12 of C and the balance of Ti and other additives.

Further, according to the present invention in which the above-mentioned manufacturing method is used for manufacturing a turbine rotor in an exhaust turbo-supercharger, there is provided a method of manufacturing a turbine rotor in an exhaust turbo-supercharger which is so configured that exhaust gas from an engine is expanded in a turbine casing and is applied to the turbine rotor which therefore directly drives a compressor for pressurizing intake air in the engine, characterized by the steps of arranging a wheel composed of a disc portion formed at the outer periphery thereof with blades, and a rod-like shaft in a furnace, their surfaces to be joined being opposed face-to-face to each other through the intermediary of a brazing solder interposed therebetween, irradiating infrared radiation to the side part of the wheel so as to heat the surfaces to be joined up to a temperature in a range from 1,000 to 1,080 deg. C. in order to melt the brazing solder, thereby the wheel and the shaft are joined to each other at their surfaces to be joined.

Further, according to the present invention as to a turbine rotor which is manufactured by using the above-mentioned manufacturing method, there is provided an exhaust turbo-supercharger which is so configured that exhaust gas from an engine is expanded in a turbine casing and is then applied to a turbine rotor which therefore directly drive a compressor for pressurizing intake air in the engine, the turbine rotor comprising a wheel composed of a disc portion formed at the outer periphery thereof with blades, and a rod-like shaft jointed to the wheel by brazing, characterized in that the wheel is made of a material composed (by wt. %) of 29 to 32 of Al, 10 to 17 of Nb, 0.05 to 0.12 of C and the balance of Ti and other additives.

According to the present invention, infrared radiation is irradiated onto the wheel side part when a wheel and a shaft which constitute a rotor such as a turbine rotor are joined to each other by brazing, and accordingly, their surfaces to be joined are heated up to a temperature in a range from 1,000 to 1,080 deg. C. with the use of a transmitted heat in order to join the surfaces by brazing. Thus, the joint by brazing can be completed without heating the shaft up to a temperature not lower than 1,100 deg. C., as has been carried out in the prior art, thereby it is possible to prevent the strength of the shaft from being lowered by the heating. It is noted that the wheel is made of metal having a high temperature resistance greatly higher than that of the shaft, no lowering of the strength is caused even though it is heated up to a temperature not lower than 1,100 deg. C.

Thus, it is possible to eliminate the necessity of heat-treating the shaft part in order to make up for a decrease in the strength, as has been made in the prior art, after brazing, and accordingly, the man hours for manufacturing rotors including turbine rotors can be reduced due to elimination of the heat-treatment.

Further, since the infrared radiation is irradiated onto the side part of the wheel which is therefore heated up, occurrence of local temperature rise of the wheel as experienced in high frequency heating in the prior art can be restrained even though a wheel having a complicated configuration is heated by infrared radiation, and accordingly, there can be uniformly heated the wheel so as to prevent conventionally experienced lowering of the strength of the joined part due to such a fact that Fe is diffused in the shaft, being caused by heating at a high temperature of 1,100 deg. C., the Fe reacting with C added in the Ti—Al, resulting in the formation of an extremely fragile carbide in the interface in the joined part. Thus, the strength of the joined part by brazing can be enhanced.

Further, the shaft can be maintained at a temperature which is relatively lower than the heating temperature not lower than 1,100 deg. C. as used in the prior art, and accordingly, a residual stress in the vicinity of the joined part after cooling of the rotor having been joined, can be reduced, thereby it is possible to prevent occurrence of disadvantages including cracking of a part in the vicinity of the joined part, and breakage of the joined part by an external force. It is noted that the linear expansion coefficient of the wheel is extremely less than that of the shaft, and accordingly, a residual stress existing therein after cooling is extremely small.

Further, since the wheel of each of rotors including the above-mentioned rotor, which is made of Ti-Ai group alloy, contains 0.05 to 0.012 (Wt. %) of C as one of components therein, by setting the additive amount of C to a value in the above-mentioned range, the creep strength thereof can be enhanced without lowering the toughness of the wheel, and accordingly, the rotor can be prevented from diametrically swelling even though it is used in exhaust gas at a high temperature which is not lower than 950 deg. C., thereby it is possible to prevent breakage of the rotor during operation at a high temperature.

Thus, it is possible to enhance the durability and the reliability of rotors including a turbine rotor.

### BRIEF DESCRIPTION OF THE DRAWINGS

FIGS. 1A to 1D are views for explaining a process of manufacturing a turbine rotor in an embodiment of the present invention;

FIG. 2A is a graph showing a comparison of time-variation in extension at a high temperature between a turbine rotor A made of Ti—Al group ally added with C (carbon) in the present invention and a conventional turbine rotor B made of Ti—Al group alloy, as a result of experiments;

FIG. 2B is a graph showing a degree of swelling of the outer diameter of the turbine rotor 101 with respect to a peripheral speed of thereof at a high temperature, as a result of experiments; and

FIG. 3 is a sectional view illustrating a variable delivery type exhaust turbo-supercharger incorporating a turbine rotor to which the present invention is applied, and being sectioned along the rotating axis thereof.

### DETAILED DESCRIPTION OF THE PREFERRED EMBODIMENTS

Explanation will be hereinbelow made of an embodiment of the present invention with reference to the accompanying drawings. It is noted that dimensions, materials, configurations, relative arrangement and the like of components described in this embodiment are merely exemplified, and is not intended to limit the technical scope of the present invention thererby alone unless otherwise specified.

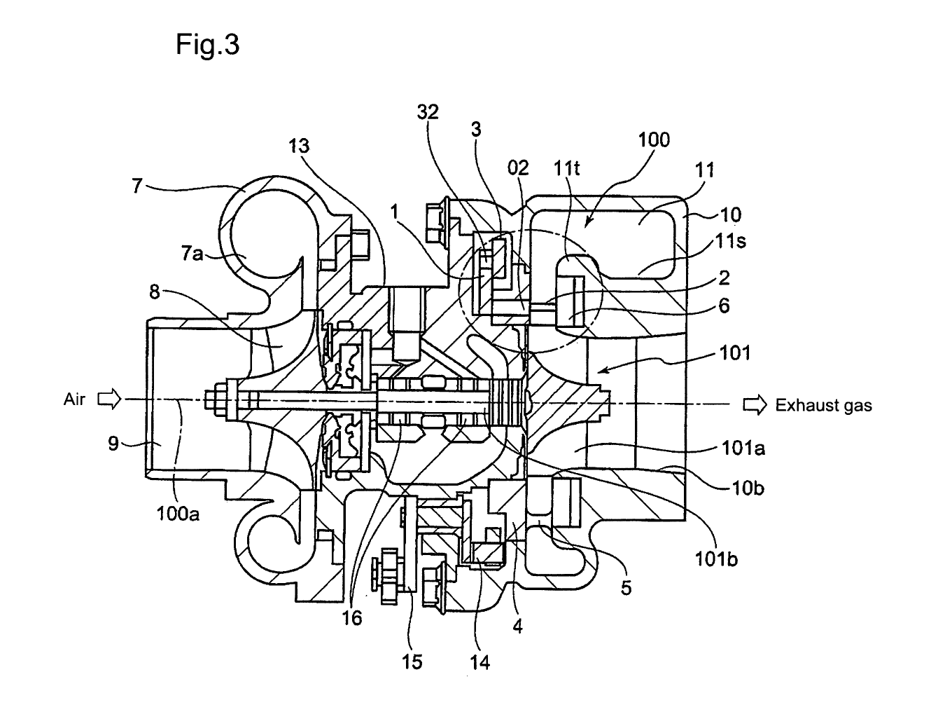

FIG. 3 is a sectional view illustrating a variable delivery type exhaust turbo-supercharger incorporating a turbine rotor to which the present invention is applied, and being sectioned along the rotating axis thereof.

Referring to FIG. 3, there are shown a turbine casing 10, a scroll 11 which are formed in a spiral-like shape in the outer peripheral part of the turbine casing 10, a radial flow turbine rotor 101 arranged coaxial with a compressor 8 and having a turbine shaft 101b which is rotatably journalled to a bearing housing 13 through the intermediary of bearings 16, a compressor housing 7 in which the compressor 8 is accommodated, an air inlet 9 of the compressor housing 7, a spiral air passage 7a and a rotating axis 10a of the exhaust turbo-supercharger.

The above-mentioned turbine rotor 101 is composed of a wheel 110a having a disc portion formed at its outer periphery with blades, and the turbine shaft 101b which is formed in a rod-like shape, the wheel 111a and the rod-like turbine shaft 101b being joined by brazing.

Explanation will be made of the operation of the exhaust turbo-supercharger configured as stated above. Exhaust gas from an engine (which is not shown) flows into the scroll 11 so as to be whirled along the spiral air passage in the scroll 11, and flows into nozzle vanes 2. Having flown through gaps between the nozzle vanes 2, the exhaust gas is then led into the turbine rotor 101, flowing from the outer periphery to the center of the turbine rotor in the radial direction in order to exert expansion work upon the turbine rotor 101. Thereafter, the exhaust gas flows out in the axial direction, being led into a gas outlet 10b, and is then discharged outside of the exhaust turbo-supercharger.

The present invention concerns a method of manufacturing a brazed rotor such as the turbine rotor 101 used in an exhaust turbo-supercharger as stated above and a configuration of a wheel for the rotor.

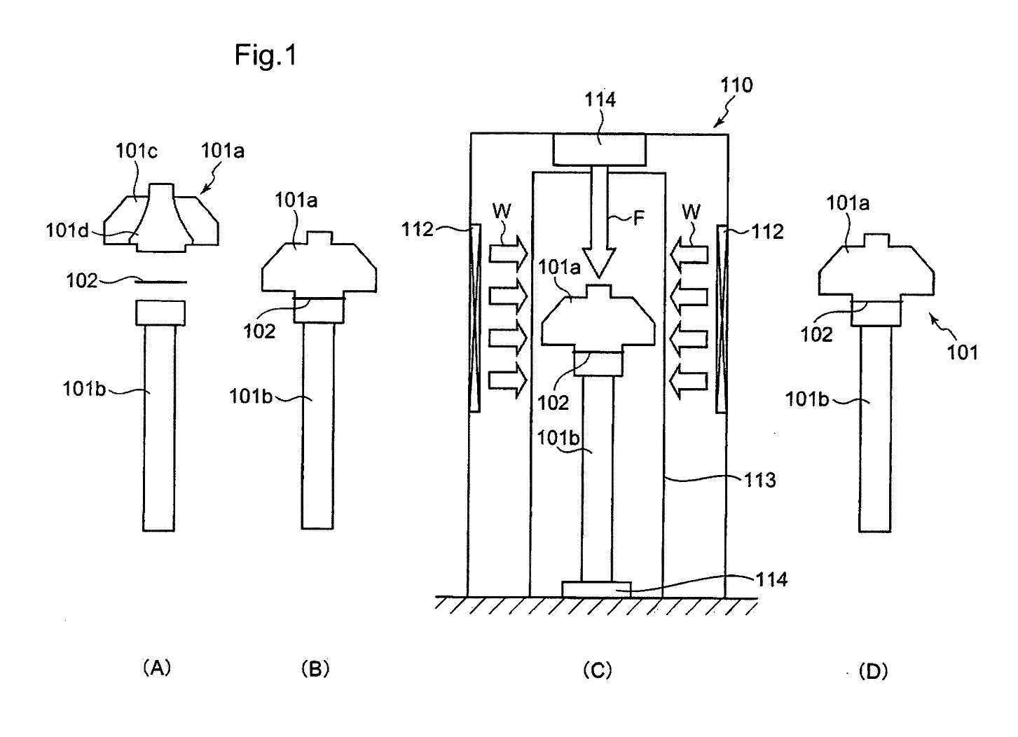

FIGS. 1A to 1D are views for explaining process steps for manufacturing the turbine rotor in this embodiment of the present invention.

Referring to FIGS. 1A to 1D, the turbine rotor 101 is manufactured in such a manner that the wheel 110a formed from a precise casting in which the disc portion 110d is integrally incorporated at its outer periphery with a plurality of blades 101c is joined thereto with the turbine shaft 101b by brazing.

Explanation will be made of process steps for manufacturing the turbine rotor 101 with reference to FIG. 1A to 1D.

At first, referring to FIG. 1A, the wheel 110a and the turbine shaft 101b are fabricated, separate from each other. A brazing solder 102 made of Ni or Ni alloy is prepared, being cut into predetermined dimensions.

The above-mentioned wheel 110a is made of Ti—Al group alloy which consists of (by wt. %) 29 to 32 of Al, 10 to 17 of Nb, 0.05 to 0.12 of C and the balance of Ti and other additive components. In this case, 0.08 (wt. %) of C is most preferable in the above-mentioned range of C (carbon).

The above-mentioned composition (wt. %) of the alloy of the wheel is set in view of the following matters:

(1) As to Addition of C (Carbon) and its Composition:

Should the conventional Ti—Al group alloy be heated up to a temperature not lower than 950 deg. C. which is the service temperature of the turbine rotor 101, the outer diameter of the wheel 110a would swell due to a creep deformation during the operation of the turbine rotor 101 so as to be made into contact with the turbine casing (refer to FIG. 3), and accordingly, would possibly damage the turbine rotor 101.

However, the wheel 101a made of the Ti—Al alloy added thereto with C (carbon) can reduce the degree of swelling even through it is heated up to a temperature not lower than 950 deg. C. since the creep strength is increased due to the addition of C (carbon), thereby it is possible to avoid damaging the turbine rotor 101 due to the above-mentioned contact.

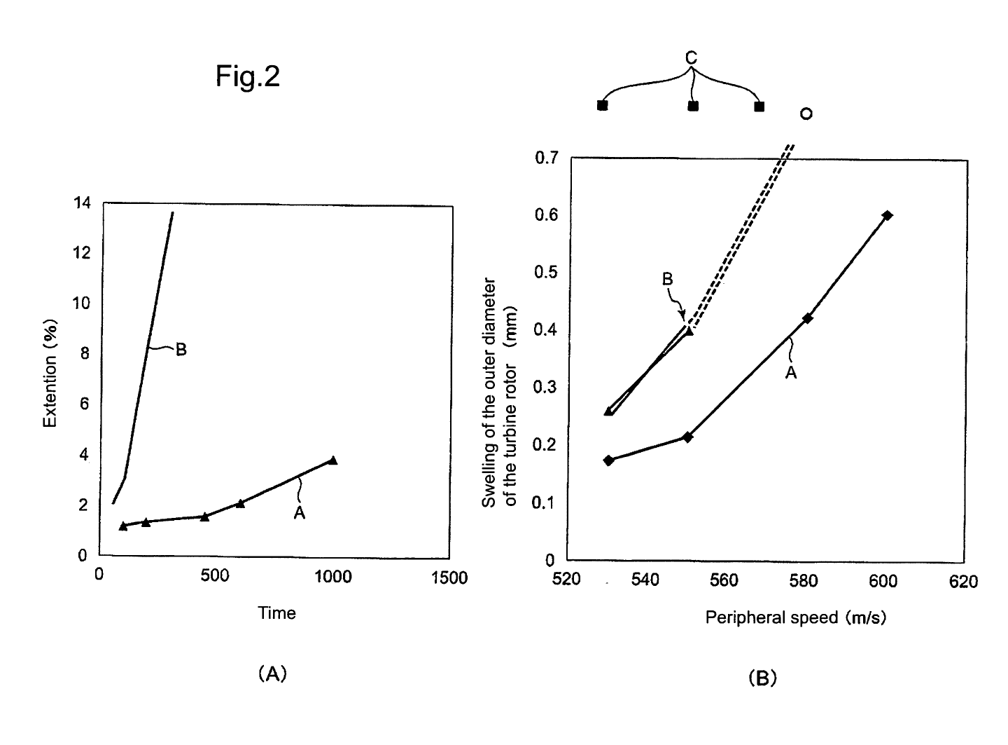

FIG. 2A shows a graph for explaining a comparison as to time variation in extension during operation at a high temperature (metal temperature of 850 deg. C.) under experimental measurements between a turbine rotor A made of Ti—Al group alloy added thereto with C (carbon) according to the embodiment of the present invention, and a turbine rotor B made of conventional Ti—Al group alloy.

FIG. 2B shows a result of experimental measurements as to a degree of swelling of the outer diameter with respect to a peripheral speed of the turbine rotor 101 during operation at a high temperature (gas temperature of 1,000 deg. C.), in which A is the Ti—Al group alloy added with C (carbon) according to the present invention, B is Ti—Al group alloy added with a less amount of C (carbon), and C is a conventional Nickel alloy.

As clearly understood from FIG. 2A, the Ti—Al group alloy added with C (carbon) according to the embodiment of the present invention exhibits an increase in extension, which is less than that of the conventional Ti—Al group alloy during operation at a high temperature (metal temperature of 850 deg. C.), and accordingly, as clearly understood from FIG. 2B, the degree of swelling of the outer diameter becomes less during operation at a high temperature (gas temperature of 1,000 deg. C.).

Further, if a Ti—Al group alloy is added thereto with C (carbon), the creep strength thereof can be enhanced but the toughness thereof is lowered. However, these vary depending upon an additive amount of C. If the additive amount of C is not less than 0.05 (wt. %), an increase in creep strength is insufficient, and accordingly it is inappropriate for a turbine rotor which requires a creep strength at a high temperature.

Meanwhile, if the additive amount of C exceeds (0.12 Wt. %), a decrease C in toughness becomes remarkable due to addition of C, that is, the degree of fragileness becomes large, which increases the possibility of occurrence of breakage during fabrication of a turbine rotor, occurrence of breakage due to impingement of even small-sized objects thereto or the like.

Thus, a component range of C (carbon) from 0.05 to 0.12 (wt. %) is appropriate, and 0.08 (wt. %) of C is optimum.

(2) As to the Content Range of Al (Aluminum):

The density of Al is the one which determines a basic structural state (two-phase alloy of γ+α2) in a Ti—Al group alloy, where α2 is a fragile phase, having a high strength at a high temperature.

If the content of the Al is not greater than 29 (wt. %), the rate of the α2 becomes excessive, resulting in an increase in fragileness.

If the content of the Al exceeds 32 (Wt. %), the rate of the α2 becomes extremely less, resulting an increase in degree of lowering of strength at a high temperature.

Thus, 29 to 32 (Wt. %) of Al is appropriate.

(3) As to a Content Range of Nb:

The density of Nb has a role of enhancing an oxidation resistance, that is, the larger the additive amount of Nb, the greater the oxidation resistance, but the larger the specific weight, the higher the product costs.

Should the content of Nb be not greater than 10 (Wt. %), the effect of enhancing the oxidation resistance would be insufficient, resulting in remarkable decrease in the wall thickness of blades during operation at a high temperature.

If the content of the Nb exceeds 17 (Wt. %), the specific weight is increased while the product costs becomes excessive high, and accordingly, the alloy cannot be used for a turbine rotor.

Thus, 10 to 17 Wt. % of Nb is appropriate.

As stated above, since the content of C is set in a range from 0.05 to 12 (Wt. %) in the wheel 110a of the turbine rotor 101, which is made of Ti—Al group alloy, the creep strength of the wheel 111a can be enhanced without lowering the toughness thereof by setting the additive amount of C in the above-mentioned range, the swelling of the outer diameter of the turbine rotor 101 can be restrained even during operation at a high temperature not lower than 950 deg. C. which is the temperature of exhaust gas, thereby it is possible to prevent occurrence of breakage of the turbine rotor 101 during operation at a high temperature.

Next, as shown in FIG. 1b, the wheel 111a having the composition ranges which are set on the basis as stated, and the turbine shaft 101b made of heat-resistance steel are opposed to each other with the brazing solder 102 being interposed therebetween, and are then carried on a support bed 114 provided in a quartz glass pipe 113 which is located in a furnace 110 as shown in FIG. 1C. Thereafter, the quartz glass pipe is filled therein with inert gas.

Further, as shown in FIG. 1C, infrared radiation W is irradiated onto the side part of the wheel 111a from heating units 112 which are arranged circumferentially as predetermined intervals along the side part of the furnace 110 while the surfaces to be joined between which the brazing solder 102 is interposed, are pressed by a load F applied onto the wheel 111a by a press unit 114 which is provided in the upper portion of the furnace 110. Thus, the surfaces to be joined are heated up to a temperature in a range from 1,000 to 1,080 deg. C. in order to melt the brazing solder 102.

Thus the wheel 110a and the turbine shaft 101b are firmly joined to each other at the surfaces to be joined.

Next, as shown in FIG. 1D, the turbine rotor 101 which has been joined as stated above, is then taken out from the furnace 110, and after removing burrs around the part joined by brazing, the outer periphery of the joined part between the wheel 101a and the turbine shaft 101b and as well the outer peripheral surface of the turbine shaft 101 are machine-finished by grinding or the like.

In this case, since it is not necessary to heat the turbine shaft 101b up to a high temperature of not lower than 1,100 deg. C., as made in the prior art, thus no heat treatment is made for the wheel 110a and the turbine shaft 101 after joining therebetween.

In the embodiment as stated above, the wheel 110a and the turbine shaft 101b which constitute the turbine rotor 101 are joined by brazing in such a manner that their surfaces to be joined are heated up to a temperature in the range from 1,000 to 1,080 deg. C. by irradiating the infrared radiation W onto the side part of the wheel 110a, and accordingly, they can be joined by brazing without the turbine shaft 101b being heated up to a high temperature not lower than 1,100 deg. C. as in the prior art, and accordingly, it is possible to avoid lowering the strength of the turbine shaft 101b at a high temperature due to heating.

Thereby it is possible to eliminate the necessity of heat-treatment of the turbine shaft 101b part for making up for lowering of the strength thereof after brazing as in the prior art. Thus, due to the elimination of the necessity of the heat-treatment process, thereby it is possible to reduce the man hours for manufacturing the turbine rotor 101 can be reduced.

Further, since the infrared radiation W is irradiated onto the side part of the wheel 110a so as to heat the wheel 110a in order to heat the surfaces to be joined by its transmission heat, there can be prevented occurrence of lowering of the strength of the joined part, being caused by such a fact that Fe is diffused in the turbine shaft 101b so as to react with C in the Ti—Al group alloy, resulting in the formation of fragile carbide in the joined interface as the turbine shaft 101b is heated up to a high temperature not lower than 1,100 deg. C. as in the prior art, thereby it is possible to enhance the strength of the joined part by brazing.

Further, since the turbine shaft 101b having a large linear coefficient of expansion is heated at a temperature which is extremely lower than the heating temperature not lower than 1,100 deg. C. under high-frequency heating as in the prior art, a residual stress around the joined part after cooling of the turbine rotor 101 which has been joined, can be reduced, thereby it is possible to prevent occurrence of disadvantages such as cracking caused by the residual stress around the joined part, breakage caused by an external force or the like.

The present invention should not be limited to the above-mentioned embodiment, that is, the present invention can be applied in general to a manufacture of a rotor which is formed of a wheel composed of a disc portion formed at its outer periphery with blades, and a rod-like shaft joined to the wheel by brazing.

According to the present invention, there can be provided a brazed rotor composed of a wheel and a shaft joined to the former by brazing, in which the durability and the reliability can be enhanced by increasing the strength of the part joined by brazing between the wheel and the shaft, without the manufacturing man hours being increased, and can be also provided a method of manufacturing a turbine rotor for an exhaust turbo-supercharger.

1. A method of manufacturing a rotor in which a wheel composed of a disc portion formed at its outer periphery with blades, and a rod-like shaft are joined by brazing, characterized by the steps of
arranging the wheel and the shaft in a furnace with their surfaces to be joined being opposed to each other through the intermediary of a brazing solder,
irradiating infrared radiation onto a side part of the wheel so as to heat the surfaces to be joined up to a temperature in a range from 1,000 to 1,080 deg. C., in order to melt the brazing solder for joining the wheel and the shaft to each other at their surfaces to be joined.

2. A method of manufacturing a rotor as set forth in claim 1, characterized in that a heat-treatment of the shaft after the joining is eliminated.

3. A rotor comprising a wheel composed of a disc portion formed at its outer periphery with blades, and a rod-like shaft joined to the wheel by brazing, characterized in that
the wheel is made of a material composed of (by Wt. %) 29 to 32 of Al, 10 to 17 of Nb, 0.05 to 0.12 of C and the balance of Ti and other additive components.

4. A method of manufacturing a turbine rotor in an exhaust turbo-supercharger in which exhaust gas from an engine is expanded in a turbine casing and is then applied to the turbine rotor in order to directly drive a compressor for pressurizing engine inlet air by the turbine rotor, and in which the turbine shaft is composed of a wheel having a disc portion formed at the periphery thereof blades, and a shaft (turbine shaft) joined to the wheel by brazing, characterized by the steps of:
arranging the wheel and the shaft (turbine shaft) in a furnace with their surfaces to be joined being opposed to each other through the intermediary of a brazing solder,
irradiating infrared radiation onto a side part of the wheel so as to heat the surfaces to be joined up to a temperature in a range from 1,000 to 1,080 deg. C., in order to melt the brazing solder for joining the wheel and the shaft at their surfaces to be joined.

5. An exhaust turbo-supercharger in which exhaust gas form an engine is expanded in a turbine casing and is then applied to the turbine rotor in order to directly drive a compressor for pressurizing engine inlet air by the turbine rotor, and in which the turbine shaft is composed of a wheel having a disk portion formed at the outer periphery thereof blades and a shaft (turbine shaft) joined to the wheel, characterized in that the wheel of the turbine rotor is made of a material composed of (by Wt. %) 29 to 32 of Al, 10 to 17 of Nb, 0.05 to 0.12 of C and the balance of Ti and other additive components.
